(19) United States
(12) Patent Application Publication
(10) Pub. No.: US 2007/0182728 A1
(43) Pub. Date: Aug. 9, 2007

(54) IMAGE DISPLAY SYSTEM, IMAGE DISPLAY METHOD, IMAGE DISPLAY PROGRAM, RECORDING MEDIUM, DATA PROCESSING APPARATUS, AND IMAGE DISPLAY APPARATUS

(75) Inventor: Toshiki FUJIMORI, Chino-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/671,689

(22) Filed: Feb. 6, 2007

(30) Foreign Application Priority Data
Feb. 6, 2006 (JP) 2006-028801

(51) Int. Cl. G09G 5/00

(52) U.S. Cl. 345/204

(57) ABSTRACT

An image display system includes a data processing apparatus that processes image data, an image display apparatus that displays an image on the basis of the image data processed by the data processing apparatus, and a communication unit for data communication between the data processing apparatus and the image display apparatus. The data processing apparatus includes an image processing unit that performs predetermined image processing on image data, a contents region detection unit that detects contents regions where various types of contents data included in the image data is displayed, an encoding method selection unit that selects an encoding method corresponding to the type of contents data, an encoding unit that encodes the contents data based on the encoding method selected for each of the contents regions, and a transmission unit that transmits the various types of contents data to the image display apparatus through the communication unit.

### CROSS-REFERENCE TO RELATED APPLICATION

This application claims priority from Japanese Patent Application No. 2006-028801 filed in the Japanese Patent Office on Feb. 26, 2006, the entire disclosure of which is hereby incorporated by reference in its entirety.

### BACKGROUND

1. Technical Field

Embodiments of the present invention relate to an image display system, an image display method, an image display program, a recording medium, a data processing apparatus, and an image display apparatus.

2. Related Art

There is known an image display system including a personal computer (data processing apparatus) that processes image data, a liquid crystal projector (image display apparatus) that displays an image on the basis of the image data processed by the personal computer, and a USB (universal serial bus) cable (communication unit) for data communication between the personal computer and the liquid crystal projector (for example, refer to JP-A-2004-69996 (pages 15 and 16)).

In an image display system disclosed in JP-A-2004-69996 (pages 15 and 16), image data used to display an image on a liquid crystal projector is input to a personal computer, predetermined image processing is performed in the personal computer, and then the image data is transmitted to the liquid crystal projector through a USB cable. The liquid crystal projector causes the image to be displayed on a screen on the basis of the image data, which has been subjected to the image processing, received through the USB cable.

In the image display system disclosed in JPA-2004-69996 (pages 15 and 16), there is an upper limit (for example, 480 Mbps in the case of USB2.0 standard) in the communication speed of a USB cable. Accordingly, if the image data for which the image processing has been performed by the personal computer is transmitted through the USB cable without any change, it is not possible to realize a typical frame rate (60 fps) in a liquid crystal projector. Taking into consideration the fact, the resolution of a liquid crystal projector is reduced or image data is compressed as necessary.

However, the method of reducing the resolution or compressing the image data may cause a problem of degradation of image quality even though the frame rate can be increased by reducing an amount of image data transmitted through a USB cable. In particular, in the case when an image to be displayed on a liquid crystal projector is a fine image, the degradation of image quality is a critical problem.

### SUMMARY

Some embodiments of the invention provide an image display system, an image display method, an image display program, a recording medium, a data processing apparatus, and an image display apparatus capable of reducing an amount of data transmitted from a data processing apparatus to an image display apparatus through a communication unit and suppressing degradation of quality of an image displayed by the image display apparatus to the minimum.

According to an embodiment, an image display system includes a data processing apparatus that processes image data, an image display apparatus that displays an image on the basis of the image data processed by the data processing apparatus, and a communicator unit for data communication between the data processing apparatus and the image display apparatus. The data processing apparatus includes an image processing unit that performs predetermined image processing on image data, a contents region detection unit that detects contents regions where a variety of contents data included in the image data is displayed, an encoding method selection unit that selects an encoding method corresponding to the type of contents data displayed in each of the contents regions detected by the contents region detection unit, an encoding unit that encodes the contents data displayed in the corresponding contents region on the basis of the encoding method selected for each of the contents regions by the encoding method selection unit, and a transmission unit that transmits the variety of contents data, for which the image processing has been performed by the image processing unit and the encoding has been performed by the encoding unit, to the image display apparatus through the communication unit. The image display apparatus includes a receiving unit that receives the variety of contents data transmitted through the communication unit by the transmission unit, a decoding unit that decodes corresponding contents data in accordance with an encoding method that is selected by the encoding method selection unit for each of the variety of contents data received by the receiving unit, and an image display unit that displays an image on the basis of the variety of contents data decoded by the decoding unit.

In the image display system, for each of the types of contents data included in the image data, a contents region where the corresponding contents data is displayed is detected in the data processing apparatus.

Here, the contents data is largely classified into moving picture contents data and still image contents data, and more specific classification may be made. For example, the still image contents data may be classified into fine data (hereinafter, referred to as “photograph”) such as a photograph, data (hereinafter, referred to as “text data”) such as a text, a figure, or a table for presentation, and data (hereinafter, referred to as “background data”) such as a frame part of a window opened on a display of a personal computer serving as a data processing apparatus or a desktop image of a personal computer. Further, among various windows opened on the display of the personal computer serving as a data processing apparatus or various icons disposed on the desktop or within a window, a window or an icon designated or dragged by a designation unit such as a mouse may be specifically classified as “active” still image contents data (hereinafter, referred to as “active data”). In addition, the classification of contents data described above is only an example. Accordingly, the technical scope of the embodiments of the invention is not limited to the example of classification. That is, embodiments of the invention can be applied to a case in which another known classification method is adopted.

The data processing apparatus detects each contents region where each contents data is displayed when a plurality of types of contents data is included in the image data. Even though details of the region detection method will be described later, a known region detection method other than that will be described later may be adopted.

Detection of the contents region may be performed at predetermined intervals by referring to the number of times of input of image data to a data processing apparatus. For example, the detection of the contents region may be performed whenever the image data is input to the data processing apparatus or with a predetermined time interval. In embodiments of the invention, another known time interval may be used.

In addition, in the data processing apparatus, an encoding method of contents data is selected for each of the detected contents regions.

Here, selection of the encoding method is automatically performed in accordance with the type of contents data. For example, for moving picture contents data in which realization of a high frame rate has top priority and high definition is also requested, an encoding method (for example, a run-length method) in which the communication speed can be increased by data compression without degradation of image quality is selected. In addition, for photograph data (still image contents data) for which the high frame rate is not requested but the high definition is requested, an encoding method (for example, a progressive JPEG method of realizing fine display by performing sequential overwriting on an image serving as a basis), in which it takes some time (for example, time corresponding to several frames) to make display but fine display can be performed, is selected. In addition, for data (still image contents data) including text data or background data in which the high definition is not requested, an encoding method (for example, a JPEG method) capable of greatly compressing data while causing degradation of image quality is selected. In addition, the active data (for example, window or icon) which is in an active state by a user is still image contents data, but there is a high possibility that a user pays attention to the active data. Accordingly, the active data may be moved by dragging, the size of the active data may be changed when the active data is a window, or movement nay be made when a new window is created. For this reason, it is preferable to select an encoding method, in which the realization of a high frame rate has top priority, for the active data, in the same manner as the moving picture contents data. In addition, the selection of an encoding method described above is only an example. Accordingly, the technical scope of the invention is not limited to the example of selection. That is, in some embodiments, preferably, the selection of the encoding method may be automatically made according to the type of displayed contents data. The correspondence relationship between the type of contents data and an encoding method selected according to the type of contents data may be arbitrarily set according to a purpose. In addition, selectable encoding methods are not limited to those described above. For example, a “non-compression method” in which data is not compressed may be adopted as a selectable encoding method.

In addition, in the data processing apparatus, each contents data is encoded on the basis of each selected encoding method and is then transmitted to the image display apparatus through the communication unit.

In the image display apparatus, each of the contents data received through the communication unit is decoded in accordance with an encoding method that is selected with respect to each of the contents data in the data processing apparatus. Then, the image display apparatus performs image display on the basis of each decoded contents data.

According to the image display system described above, as for contents data (for example, text data or background data) for which high definition is not requested, it is possible to reduce an amount of data transmitted from the data processing apparatus to the image display apparatus through the communication unit by selecting an encoding method capable of greatly compressing data. On the other hand, as for contents data (for example, moving picture contents data or photograph data) for which high definition is requested, it is possible to suppress degradation of quality of an image displayed by the image display apparatus to the mini mum by selecting an encoding method which does not cause the degradation of an image.

In the image display system described above, preferably, the data processing apparatus further includes a transmission priority setting unit that sets transmission priorities on the variety of contents data included in the image data, and the transmission unit transmits the variety of contents data on the basis of the transmission priorities set by the transmission priority setting unit.

According to the image display system configured as above, even when the communication speed of the communication unit is low and all types of contents data included in one frame cannot be transmitted within a frame update interval, contents data having high transmission priority can be preferentially transmitted. As a result, at least contents data having high transmission priority can be properly displayed. Here, even though the transmission priorities can be arbitrarily set according to a purpose, it is preferable to hold the frame rate of the corresponding contents data by setting a transmission priority of contents data (for example, moving picture contents data or active data), in which realization of a high, frame rate has top priority, to be high.

Further, in the image display system described above, it is preferable that the contents region detection unit include a time change detection unit that detects time change of each pixel data included in the image data and a moving picture contents region detection unit that detects a moving picture contents region, in which moving picture contents data included in the image data is displayed, on the basis of the time change of each of the pixel data detected by the time change detection unit.

According to the image display system configured as above, by detecting the time change of each of the pixel data included in the image data, it is possible to efficiently detect a region, in which the time change of pixel data is large, as a moving picture contents region.

Furthermore, in the image display system described above, it is preferable that the contents region detection unit include a boundary detection unit that detects, as a boundary of the contents regions, a part of the image data having large change between adjacent pixel data.

Since different types of contents data are displayed in different contents regions, there is a possibility that pixel data will be greatly changed on a boundary of the contents regions. According to the image display system described above, by comparing adjacent pixel data of image data, a part in which the change of pixel data is large can be efficiently detected as a boundary of contents regions.

According to some embodiments, an image display method executed by an image display system having a data processing apparatus that processes image data, an image display apparatus that displays an image on the basis of the image data processed by the data processing apparatus, and a communication unit for data communication between the data processing apparatus and the image display apparatus includes: performing predetermined image processing on image data by means of the data processing apparatus; detecting contents regions in which a variety of contents data included in the image data is displayed, by means of the data processing apparatus; selecting an encoding method corresponding to the type of contents data displayed in each of the contents regions detected in the detecting of the contents regions, by means of the data processing apparatus; encoding the contents data displayed in the corresponding contents region on the basis of the encoding method selected for each of the contents regions in the selecting of the encoding method, by means of the data processing apparatus, transmitting the variety of contents data, for which the image processing in the performing of the predetermined image processing and the encoding in the encoding of the contents data have been performed, to the image display apparatus through the communication unit, by means of the data processing apparatus; receiving the variety of contents data transmitted through the communication unit in the transmitting of the variety of contents data, by means of the image display apparatus; decoding corresponding contents data in accordance with an encoding method that is selected in the selecting of the encoding method for each of the variety of contents data received in the receiving of the variety of contents data, by means of the image display apparatus; and displaying an image on the basis of the variety of contents data decoded in the decoding of the contents data by means of the image display apparatus.

Since the image display method can be executed by the image display system described above, the same operations and effects as in the image display system can be obtained.

According to some embodiments, an image display program executed by an image display system having a data processing apparatus that processes image data, an image display apparatus that displays an image on the basis of the image data processed by the data processing apparatus, and a communication unit for data communication between the data processing apparatus and the image display apparatus causes a computer included in the data processing apparatus to execute: performing predetermined image processing on image data; detecting contents regions in which a variety of contents data included in the image data is displayed; selecting an encoding method corresponding to the type of contents data displayed in each of the contents regions detected in the detecting of the contents regions; encoding the contents data displayed in the corresponding contents region on the basis of the encoding method selected for each of the contents regions in the selecting of the encoding method; and transmitting the variety of contents data, for which the image processing in the performing of the predetermined image processing and the encoding in the encoding of the contents data have been performed, to the image display apparatus through the communication unit.

Furthermore, according to some embodiments, an image display program executed by an image display system having a data processing apparatus that processes image data, an image display apparatus that displays an image or the basis of the image data processed by the data processing apparatus, and a communication unit for data communication, between the data processing apparatus and the image display apparatus causes a computer included in the image display apparatus to execute: receiving the variety of contents data transmitted from the data processing apparatus through the communication unit; decoding corresponding contents data in accordance with an encoding method that is selected by the data processing apparatus for each of the variety of contents data received in the receiving of the variety of contents data; and displaying an image on the basis of the variety of contents data decoded in the decoding of the contents data.

In addition, according to some embodiments, there is provided a recording medium recorded with each image display program described above and readable by a computer.

Since the image display program and the recording medium are used to cause the above-described image display method to execute, the same operations and effects as in the image display method can be obtained.

In addition, embodiments of the invention can be realized by the data processing apparatus and the image display apparatus serving as an embodiment of a sub-combination invention included in the above-described image display system, and the above-described operations and effects can be achieved by cooperation of the data processing apparatus and the image display apparatus.

### BRIEF DESCRIPTION OF THE DRAWINGS

Embodiments of the invention will be described with reference to the accompanying drawings, wherein like numbers reference like elements.

FIG. 1 is a functional block diagram illustrating the configuration of an image display system.

FIG. 2 is a functional block diagram illustrating the configuration of an image processing unit.

FIG. 3 is a functional block diagram illustrating the configuration of a contents region detection unit.

FIG. 4 is a flow chart illustrating a flow of image display.

FIG. 5 is a view illustrating an example of image data input by an image data input unlit.

FIG. 6 is a series of views illustrating an example in which time change detection is performed on image data in the example shown in FIG. 5.

FIG. 7 is a view illustrating respective contents regions detected with respect to the image data in the example shown in FIG. 5.

FIG. 8 is a view illustrating a format of contents data transmitted by a transmission unit.

FIG. 9 is a view illustrating a transmission example of contents data over several frames in the example shown in FIG. 5.

### DESCRIPTION OF EXEMPLARY EMBODIMENTS

Hereinafter, an embodiment of the invention will be described with reference to the accompanying drawings.

### 1. Configuration of an Image Display System

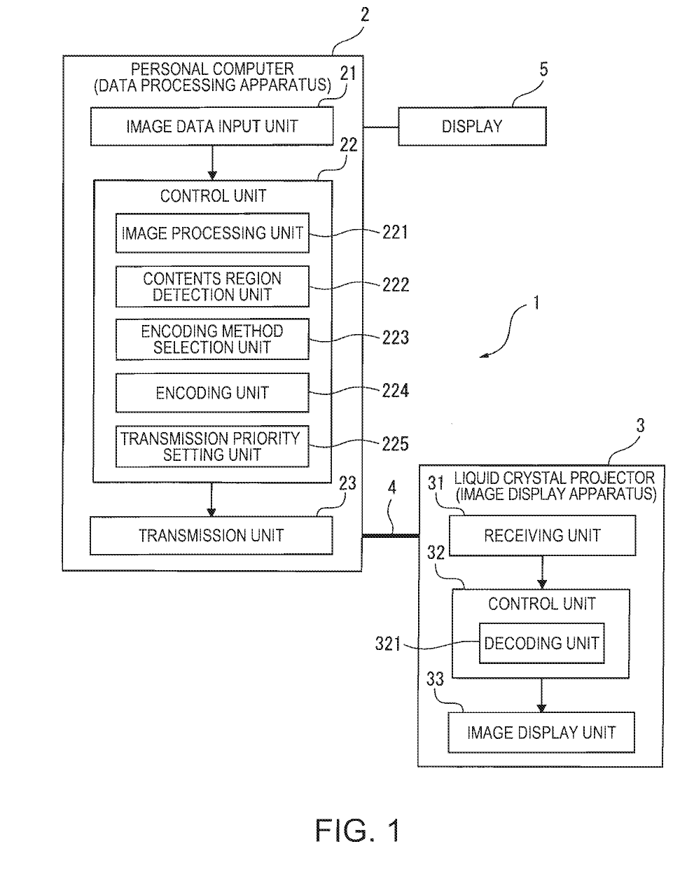

FIG. 1 is a functional block diagram illustrating, the configuration of an embodiment of an image display system.

An image display system 1 is configured to include a personal computer 2 serving as a data processing apparatus that processes image data, a liquid crystal projector 3 serving as an image display apparatus that displays an image on the basis of the image data processed by the personal computer 2, and a USB cable 4 serving as a communication unit for data communication between the personal computer 2 and the liquid crystal projector 3.

The personal computer 2 is configured to include an image data input unit 21, a control unit 22, and a transmission unit 23 from a functional point of view.

The image data input unit 21 is a unit that inputs image data, which is finally displayed on the liquid crystal projector 3, to the control unit 22. In the present embodiment, in order to display an image equal to an image displayed on a display 5 of the personal computer 2, the image data input unit 21 inputs to the control unit 22 image data acquired by capturing the image displayed on the display 5.

The control unit 22 is a unit that performs an overall control related to processing of the image data input by the image data input unit 21 and is configured to include an image processing unit 221, a contents region detection unit 222, an encoding method selection unit 223, an encoding unit 224, and a transmission priority settling unit 225 from a functional point of view.

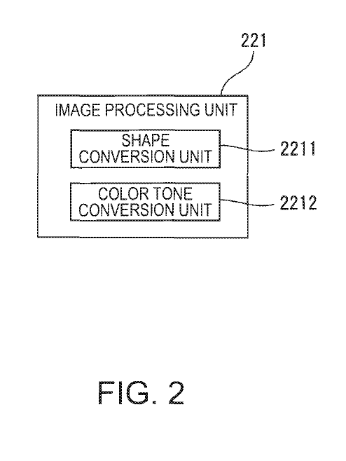

The image processing unit 221 is a unit that performs predetermined image processing on the image data input by the image data input unit 11 and is configured to include a shape conversion unit 2211 and a color tone conversion unit 2212 from a functional point of view, as shown in FIG. 2.

The shape conversion unit 2211 is a unit that converts the shape of image data in accordance with the liquid crystal projector 3 that is used. Specifically, the shape conversion unit 2211 converts (resizes) the resolution of image data in accordance with display performance of the liquid crystal projector 3 or performs trapezoidal correction on the image data in accordance with a condition in which the liquid crystal projector 3 is provided (refer to JP-A-2004-69996 for more details).

The color tone conversion unit 2212 is a unit that converts the color tone of image data in accordance with the liquid crystal projector 3 that is used. Specifically, the color tone conversion unit 2212 performs gamma correction, color unevenness correction, or the like with respect to image data in accordance with display characteristic of the liquid crystal projector 3 (refer to JP-A-2004-69996 for more details).

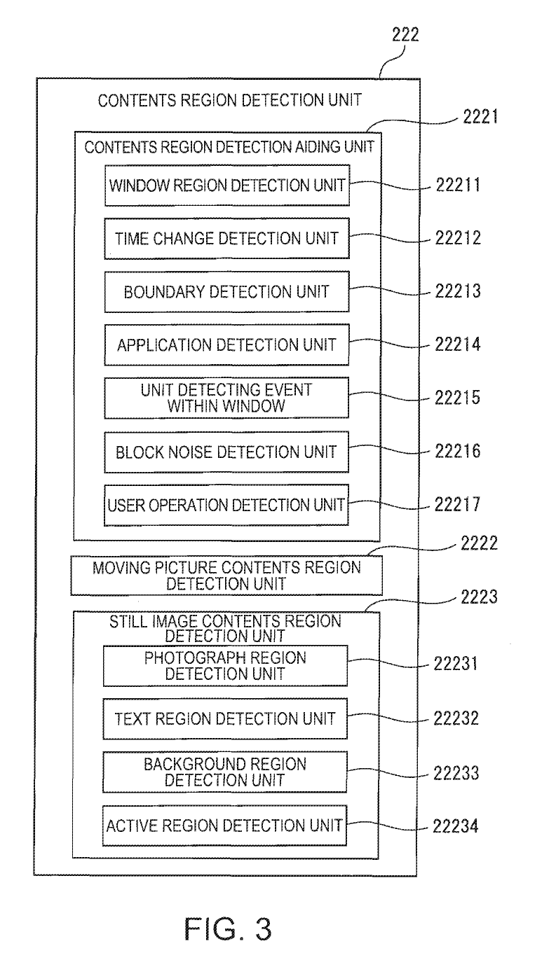

The contents region detection unit 222 is a unit that detects a contents region where a variety of contents data included in the image data input by the image data input unit 21 is displayed and is configured to include a contents region detection aiding unit 2221, a moving picture contents region detection unit 2222, and a still image contents region detection unit 2223 from a functional point of view, as shown in FIG. 3.

The contents region detection aiding unit 2221 is a unit that acquires various information useful to detect types of contents data and a contents region and is configured to include a window region detection unit 22211, a time change detection unit 22212, a boundary detection unit 22213, an application detection unit 22214, a unit 22215 detecting an event within a window, a block noise detection unit 22216, and a user operation detection unit 22217 from a functional point of view.

The window region detection unit 22211 is a unit that detects a region of a corresponding window (window region) in the case when data of window, such as application, is included in the image data input by the image data input unit 21. According to the window region detection unit 22211, it is possible to detect the window region and also detect a region, which is not detected as a window region, as a background region such as desktop.

The time change detection unit 22212 is a unit that detects the time change of each of pixel data that forms the image data input by the image data input unit 21. According to the time change detection unit 22212, it is possible to detect a region, in which there is time change in pixel data, as a moving picture contents region and to detect a region, in which there is no time change in pixel data, as a still image contents region.

The boundary detection unit 22213 is a unit that detects, as a boundary of contents regions, a part of the image data, which is input by the image data input unit 21, having large change between adjacent pixel data. By detecting the boundary of the contents regions, it is possible to accurately detect the respective contents regions.

The application detection unit 22214 is a unit that detects types of applications that form the window in the case when data of a window of an application is included in the image data input by the image data input unit 21. By detecting the type of an application, it is possible to determine the type of contents data displayed within a window.

The unit 22215 detecting an event within a window is a unit that detects an event occurring within the window in the case when data of a window, such as an application, is included in the image data input by the image data input unit 21. By detecting an event within a window, it is possible to determine the type of contents data displayed within a window.

The block noise detection unit 22216 is a unit that, when contents data whose encoding has been completed in an encoding method, such as JPEG or MPEG, is included in the image data input by the image data input unit 21, detects a block noise occurring due to the corresponding encoding method. By detecting the block noise, it is possible to accurately detect a still image contents region based on JPEG or a moving picture contents region based on MPEG.

The user operation detection unit 22217 is a unit that detects an operation performed by a user. By detecting a user's operation, it is possible to detect active data, such as an icon or a window being in an active state by the user.

The moving picture contents region detection unit 2222 is a unit that detects a moving picture contents region, in which moving picture contents data included in the image data input by the image data input unit 21 is displayed, on the basis of various information acquired by the contents region detection aiding unit 2221.

The still image contents region detection unit 2223 is a unit that detects a still image contents region, in which still image contents data included in the image data input by the image data input unit 21 is displayed, on the basis of various information acquired by the contents region detection aiding unit 2221. The still image contents region detection unit 2223 is configured to include a photograph region detection unit 22231, a text region detection unit 22232, a background region detection unit 22233, and an active region detection unit 22234 from a functional point of view.

The photograph region detection unit 22231 is a unit that detects a photograph region where fine data (thereinafter, referred to as “photograph data”), such as a photograph, among the still image contents data is displayed.

The text region detection unit 22232 is a unit that detects a text region where data (hereinafter, referred to as “text data”), such as a text, a figure, or a table for presentation, among the still image contents data is displayed. In addition, even though the photograph data and the text data are all still image contents data, it is possible to distinguish the picture data from the text data according to the density (photograph data: high, text data: low) of data.

The background region detection unit 22233 is a unit that detects a background region where data (hereinafter, referred to as “background data”), such as a desktop image or a frame part of a window, among the still image contents data is displayed.

The active region detection unit 22234 is a unit that detects an active region where active data (hereinafter, referred to as “active data”), such as an icon or a window designated or dragged by a mouse operation of a user is displayed.

The encoding method selection unit 223 is a unit that selects an encoding method according to the type of contents data, which is displayed on a corresponding contents region, for each contents region detected by the contents region detection unit 222.

The encoding unit 224 is a unit that encodes the contents data, which is displayed on the corresponding contents region, on the basis of an encoding method selected for each contents region by the encoding method selection unit 223.

The transmission priority setting unit 225 is a unit that sets transmission priorities on a variety of types of contents data included in the image data input by the image data input unit 21.

The transmission unit 23 is a unit that transmits the variety of types of contents data, for which a variety of processes have been performed in the control unit 22, to the liquid crystal projector 3 through the USB cable 4 on the basis of the transmission priorities set by the transmission priority setting unit 225. Specifically, the transmission unit 23 is configured to include a USB controller connected to the USB cable 4.

The liquid crystal projector 3 is configured to include a receiving unit 31, a control unit 32, and an image display unit 33 from a functional point of view.

The receiving unit 31 is a unit that receives a variety of types of contents data transmitted through the USB cable 4 by the transmission unit 23. Specifically, the receiving unit 31 is configured to include a USB controller connected to the USB cable 4.

The control unit 32 is a unit that performs an overall control on display of the variety of types of contents data received by the receiving unit 31 and is configured to include a decoding unit 3211 from a functional point of view.

The decoding unit 321 is a unit that decodes corresponding contents data in accordance with an encoding method, which is selected by the encoding method selection unit 223 with respect to the variety of types of contents data received by the receiving unit 31.

The image display unit 33 is a unit that displays an image on the basis of a variety of types of contents data decoded by the decoding unit 321. The image display unit 33 is configured to include a light source that emits light, a liquid crystal panel that forms an image by modulating the light emitted from the light source on the basis of image data (various types of decoded contents data), and a projection lens that projects an image formed by the liquid crystal panel.

### 2. Image Display Method

Next, it will be described about an image display method performed by the image display system 1 having the configuration described above.

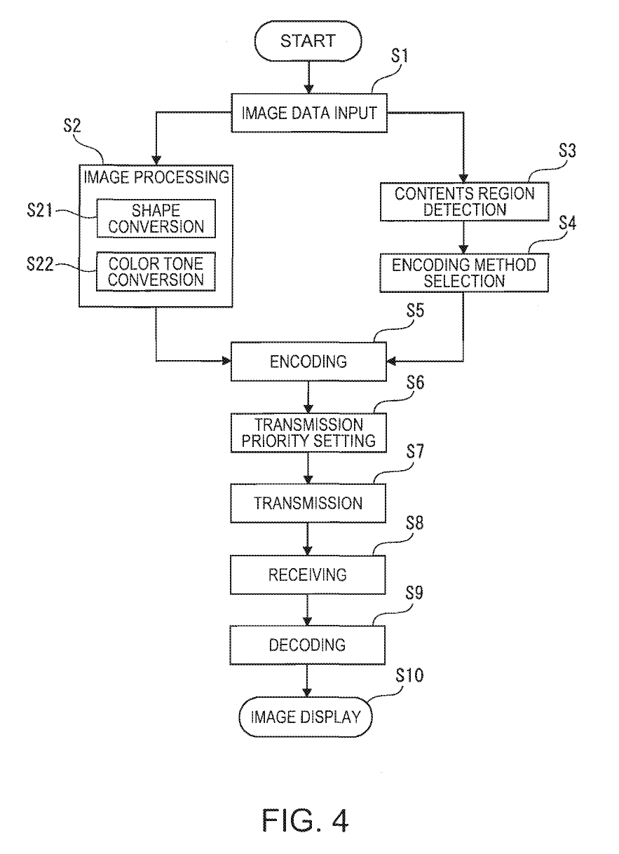

FIG. 4 is a flow chart illustrating a flow of image display.

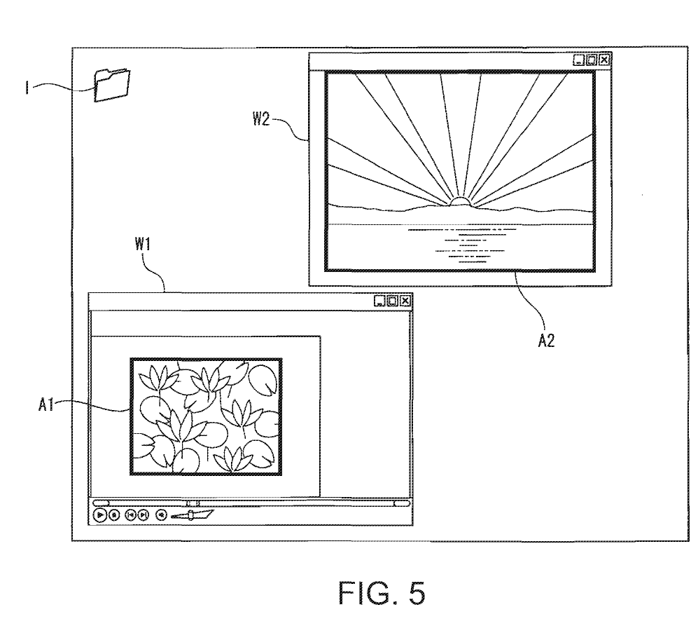

In step S1, the image data input unit 21 of the personal computer 2 inputs to the control unit 22 image data corresponding to an image displayed on the display 5 of the personal computer 2. FIG. 5 is a view illustrating an example (example of display of the display 5) of the image data input in the step S1. In the drawing, two windows W1 and W2 are open so as to be placed on a desktop on which various icons 1 are disposed. The window W1 is a window of a moving picture display application, and a moving picture is displayed in a moving picture display region A1 of the window W1. In addition, the window W2 is a window of a still image display application, and a fine photograph as a still image is displayed in a still image display region A2 of the window W2.

In step S2, the image processing unit 221 performs predetermined image processing on the image data (refer to FIG. 5) input in the step S1. Specifically, the shape conversion unit 2211 converts the shape of the image data in accordance with the liquid crystal projector 3 that is used (S21), and the color tone conversion unit 2212 converts the color tone of the image data in accordance with the liquid crystal projector 3 that is used.

In step S3, concurrently with the step S2, the contents region detection unit 222 detects a contents region where a variety of types of contents data included in the image data input in the step S1 is displayed. In the present embodiment, the contents data is classified into five types of data including moving picture contents data, photograph data, text data, background data, and active data. In the step S3, the contents region (moving picture contents region, photograph regions text region, background region, and active region) is detected for each of the types of contents data. At this time, the type of contents data and a contents region are detected on the basis of a variety of information acquired by the contents region detection aiding unit 2221. The number of executions of step S3 may be smaller than that of step S2. In the present embodiment, the step S3 is performed every predetermined time interval, and the step S3 is performed whenever an event, such as movement or creation of a window, occurs. By executing the contents region detection unit as described above, it is possible to reduce average processing time required to detect the contents region to the minimum.

According to the window region detection unit 22211, it is possible to detect a region, which is not detected as a window region, as a background region where background data is displayed by detecting a window region. In the example shown in FIG. 5, since the regions of the windows W1 and W2 are detected as window regions, a region of the desktop not detected as the window region can be detected as a background region. In addition, the windows W1 and W2 detected as the window regions include two different kinds of regions, respectively. That is, the window W1 includes a frame part and the display region A1 and the window W2 includes a frame part and the display region A2. In the strict sense, each of the windows W1 and W2 includes a plurality of contents regions. Therefore, in order to accurately detect the contents regions, it is necessary to divide the window W1 into a frame part and the display region A1 and the window W2 into a frame part and the display region A2 on the basis of the variety of information acquired by the contents region detection aiding unit 2221, which will be described below.

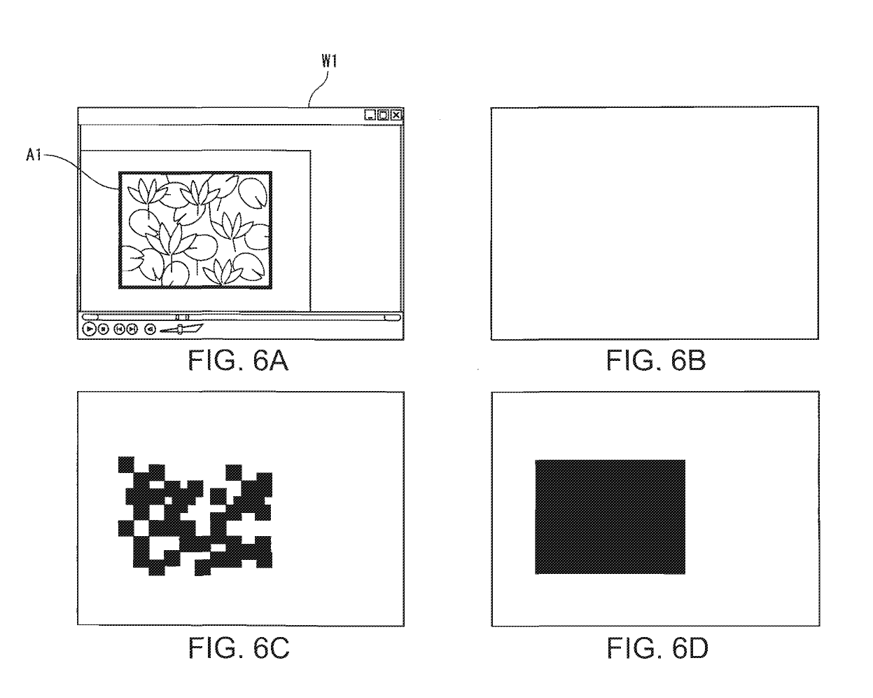

According to the time change detection unit 22212, in the image data input in the step S1, it is possible to detect a region, in which there is time change in pixel data, as a moving picture contents region and to detect a region, in which there is no time change in pixel data, as a still image contents region. FIG. 6A to 6D are a series of views illustrating an example in which the time change detection unit 22212 performs time change detection with respect to the image data in the example shown in FIG. 5. FIG. 6A illustrates a view obtained by extracting a region including the moving picture display window W1 from the image data shown in FIG. 5. FIGS. 6B to 6D are a series of views illustrating a flow of time change detection performed for the region of FIG. 6A. At the start of the time change detection in FIG. 6B, an image is white over the entire region. Then, as portions where there has been time change in pixel data are sequentially changed to have a black color (FIG. 6C), a rectangular region corresponding to the moving picture display region A1 within the window W1 is finally changed to have a black color (FIG. 6D). Thus, according to the time change detection unit 22212, it is possible to detect only the moving picture display region A1 of the window W1 and to detect the region A1 as a moving picture contents region.

According to the boundary detection unit 22213, it is possible to detect, as a boundary of contents regions, parts of the image data, which is input in the step S1, having large change between adjacent pixel data. Particularly in the present embodiment, taking into consideration that a boundary of contents regions is linear in many cases, parts in which the change between adjacent pixel data is large are detected as a boundary of contents regions only in the case when the parts are arranged in the linear shape. Accordingly for example, in the case when parts, in which change between adjacent pixel data is large, among image data of a photograph are arranged in a curve along the shape of a photographic subject, the parts are not erroneously detected as a boundary of contents regions. As a result, the detection precision of a boundary having a linear shape can be increased. By using the boundary detection unit 22213 described above, it is possible to accurately detect, for example, boundaries (rectangular shape) between the frame parts and the display regions A1 and A2 of the windows W1 and W2 in the example shown in FIG. 5. In addition, types of contents data displayed in respective contents regions separated by boundaries detected by the boundary detection unit 22213 are preferably determined on the basis of the variety of information acquired by the contents region detection aiding unit 2221

According to the application detection unit 22214, it is possible to determine the type of contents data displayed within a window by detecting the type of an application that forms a window. In an example shown in FIG. 5, it is possible to determine that contents data displayed within the corresponding window W1 is moving picture contents data by detecting the type of an application that forms the moving, picture display window W1 and to determine that contents data displayed within the corresponding window W2 is photograph data by detecting the type of an application that forms the still image display window W2.

According to the unit 22215 detecting an event within a window, it is possible to determine the type of contents data displayed within a window by detecting an event within a window. In the example shown in FIG. 5, it is possible to determine that contents data displayed within the corresponding window W1 is moving picture contents data by detecting an event (for example, reproduction, stop, forward, rewind, or volume control) within the moving picture display window W1 and to determine that contents data displayed within the corresponding window W2 is photograph data by detecting an event (for example, enlargement, reduction, or page skip) within the still image display window W2.

According to the block noise detection unit 22216, it is possible to accurately detect a still image contents region based on JPEG or a moving picture contents region based on MPEG by detecting a block noise. In the example shown in FIG. 5, when the moving picture contents data displayed within the moving picture display window W1 is encoded on the basis of MPEG, it is possible to detect a contents region of the moving picture contents data by the block noise detection, and when the still image contents data displayed within the still image display window W2 is encoded on the basis of JPEG, it is possible to detect a contents region of the still image contents data by the block noise detection.

According to the user operation detection unit 22217, by detecting a user's mouse operation or the like, it is possible to accurately detect active data, such as an icon I or the windows W1 and W2 being in active states by the user, and also accurately detect an active region where corresponding active data is displayed.

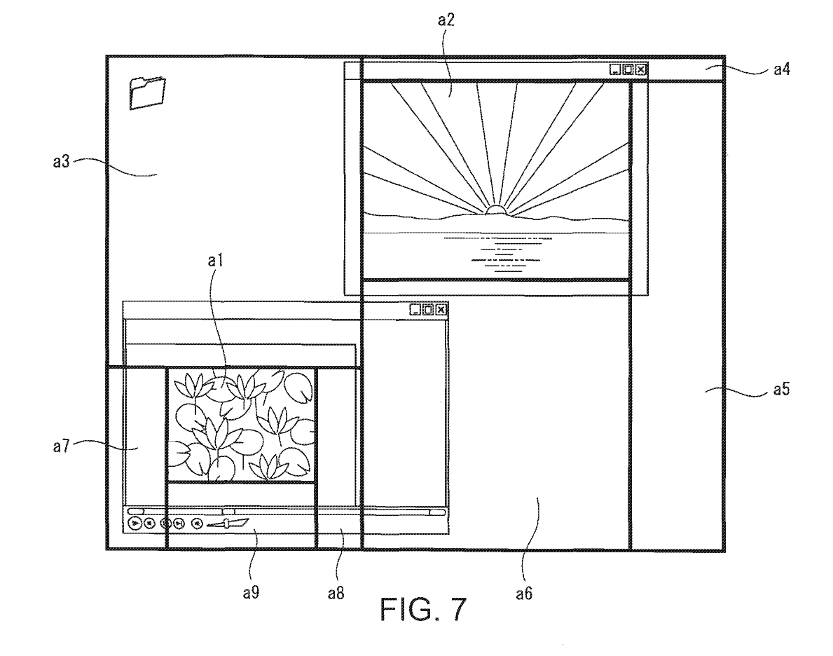

In the step S3, the detection of each contents region is performed by the moving picture contents region detection unit 2222 and the still image contents region detection unit 2223 on the basis of the variety of information acquired by the contents region detection aiding unit 2221. In the example shown in FIG. 5, the image data mainly includes three types of contents data, that is, the moving picture contents data displayed within the moving picture display window W1, the photograph data displayed within the still image display window W2, and background data (frame parts of the windows W1 and W2 or data on desktop) other than both the moving picture contents data and the photograph data. Accordingly, in the step S3, the moving picture display region A1 where the moving picture contents data is displayed, the still image display region A2 where the photograph data is displayed, and a region other than both the regions A1 and A2 where background data is displayed are detected as contents regions moving picture contents region, photograph region, and background region), respectively. FIG. 7 is a view illustrating the respective contents regions detected with respect to the image data in the example shown in FIG. 5. Among nine rectangular contents regions a1 to a9 shown in FIG. 7, a1 indicates a moving picture contents region (same as the moving picture display region A1 of the window W1), a2 indicates photograph region (same as the still image display region A2 of the window W2), and a3 to a9 indicate a background region. Here, the image data is divided into the rectangular contents regions a1 to a9 because processing can be simplified when the data is divided in the rectangular shape.

In step S4, the encoding method selection unit 223 selects an encoding method according to the type of contents data, which is displayed on a corresponding contents region, for each contents region detected in the step S3. Specifically, in a moving picture contents region where realization of a high frame rate has top priority and high definition is also requested, a run-length method in which the communication speed can be increased by data compression without degradation of image quality is selected as an encoding method. In addition, in a photograph region where the high frame rate is not requested but the high definition is requested, a progressive JPEG method in which it takes some time (for example, time corresponding to several frames) to make display but fine display can be performed is selected as an encoding method. In addition, in a text region and a background region where the high definition is not requested, a J-PEG method capable of greatly compressing data while causing degradation of image quality is selected as an encoding method. In addition, in an active region to which there is a high possibility that a user pays attention and in which active data with various movements (for example, movement made by dragging) is displayed, the run-length method in which the realization of a high frame rate has top priority is selected as an encoding method, in the same manner as the moving picture contents region.

In step S5, the encoding unit 224 encodes contents data, which is displayed on a corresponding contents region, on the basis of an encoding method selected for each contents region in the step S4. Moreover, the encoding is performed with respect to image data (contents data) after image processing in the step S2.

In step S6, the transmission priority setting unit 225 sets a transmission priority on a variety of contents data that has been encoded in the step S5. Specifically, as for the variety of contents data, a first transmission priority is set for moving picture contents data, a second transmission priority is set for active data, a third transmission priority is set for photograph data, a fourth transmission priority is set for text data, and a fifth transmission priority is set for background data. In the example shown in FIG. 5, as for the nine contents regions a1 to a9 shown in FIG. 7, the transmission priorities are set in the following order of a1 (moving picture contents data)->a2 (photograph data)->a3 to a9 (background data).

In step S7, the transmission unit 23 transmits the variety of contents data whose transmission priorities have been set in the step S6 to the liquid crystal projector 3 through the USB cable 4 on the basis of the transmission priorities.

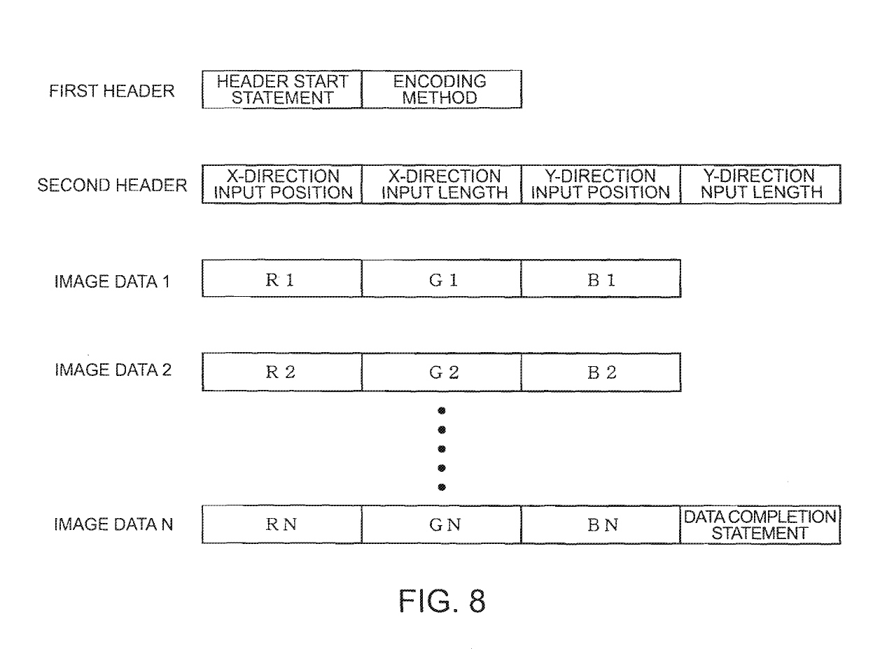

FIG. 8 is a view illustrating a format of contents data transmitted in the step S7. The contents data includes two headers and a group of pixel data. A first header indicates a method of the encoding performed on corresponding contents data in the step S5. The encoding method is the same as that selected with respect to the contents data in the step S4. A second header indicates an input range of contents data. The input range corresponds to a contents region where the contents data is displayed and is specified by four data including an K-direction input position, an X-direction input length, a Y-direction input position, and a Y-direction input length (the input range has a rectangular shape). The group of pixel data includes pixel data of “n” pixels included in the input range having the rectangular shape. Each pixel data includes a set of three values of (t, C, B).

In the example shown in FIG. 5, as shown in FIG. 7, the image data is divided into the nine contents regions a1 to a9. Accordingly, one-frame image data includes nine contents data (each of the nine contents data is data having a format displayed shown in FIG. 8) corresponding to the contents regions a1 to a9. Here, if the communication speed of the USB cable 4 that performs communication of each contents data is sufficient, all of the nine contents data included in, one frame can be transmitted from the personal computer 2 to the liquid crystal projector 3 through the USB cable 4 within a frame update interval. However, if the communication speed of the USB cable 4 is not sufficient, all of the nine contents data cannot be transmitted within a frame update interval, and accordingly, only a transmittable amount of data is to be transmitted on the basis of the transmission priorities set in the step S6. In the example shown in FIG. 5, as described above, the transmission priorities are set in the order of a1 (moving picture contents data)->a2 (photograph data)->a3 to a9 (background data). Accordingly, transmission of the moving picture contents data displayed in the contents region a1 has top priority.

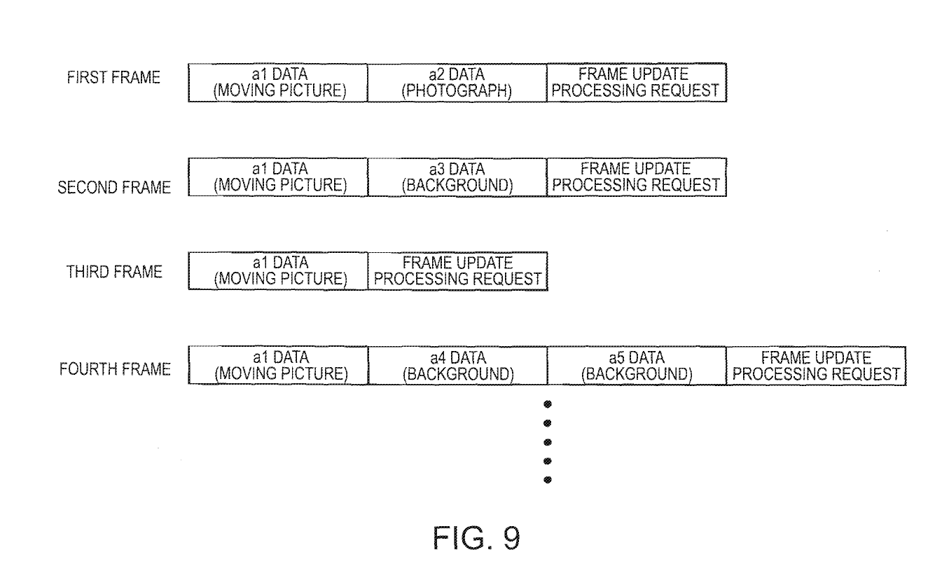

FIG. 9 is a view illustrating a transmission example of contents data over several frames in the example shown in FIG. 5. In this example, in order to give top priority to holding of a frame rate of the moving picture contents data displayed in the contents region a1, contents data (moving picture contents data: first transmission priority) of the contents region a1 is to be transmitted with highest priority in all frames. In addition, the contents data of the contents regions a2 to a9 having transmission priorities lower than that of the contents region a1 is transmitted according to the transmission priorities set for the contents data only in the case when there is enough time until frame update timing after transmitting the contents data of the contents region a1.

At a first frame, frame update timing occurs at a point of time when the contents data (photograph data) of the contents region a2 has been transmitted after transmitting the contents data of the contents region a1. Accordingly, a frame is updated in a state in which contents data of the other contents regions a3 to a9 is not transmitted. Then, at a second frame, the contents data (background data) of the contents region a3, which could not be transmitted at the previous frame after transmission of the contents data of the contents region a1, is transmitted (contents data of the contents region a2 is “skipped” since the contents data of the contents region a2 has been completely transmitted at the first frame). At a third frame, the frame update timing occurs at a point of time when the contents data of the contents region a1 has been transmitted. Accordingly, a frame is updated in a state in which contents data of the other contents regions a2 to a9 is not transmitted. Then, at a fourth frame, the contents data (background data) of the contents regions a4 and a5, which could not be transmitted at the previous frame after transmission of the contents data of the contents region a1, is transmitted (contents data of the contents regions a2 and a3 is “skipped” since the contents data of the contents regions a2 and a3 has been completely transmitted at the first and second frames). Thereafter, in the same manner as described above, the contents data of the other contents regions a2 to a9 is transmitted while the transmission of the contents data of the contents region a1 has top priority.

Further, in the example described above, update frequency of the contents data of the contents region a1 to a9 may be considerably reduced depending on communication state of the USB cable 4. Therefore, contents data of each contents region is forced to be periodically updated at least once in predetermined several frames (for example, 60 frames). In this way, it is possible to perform minimum update on all of the contents data. In addition, the compulsory update of contents data may be simultaneously performed at the same timing with respect to all contents regions or may be sequentially performed with respect to the respective contents regions so as to deviate from each other by predetermined frames.

In step S8, the receiving unit 31 of the liquid crystal projector 3 receives the variety of contents data transmitted through the USB cable in the step S7.

In step S9, the decoding unit 321 decodes the variety of contents data received in the step S8 in accordance with an encoding method selected in the step S4. Specifically, the decoding unit 321 recognizes an encoding method of contents data to be decoded by referring to the first header, which indicates an encoding method in the format of the contents data shown in FIG. 8, and decodes the contents data in accordance with the encoding method.

In step S10, the image display unit 33 displays an image on the basis of the variety of contents data decoded in the step S9. In addition, the displayed image is projected onto a screen or the like.

### 3. Effects of Embodiment

According to the embodiment described above, an encoding method is selected corresponding to the type of contents data. As a result, as for contents data (text data or background data) for which high definition is not requested, it is possible to reduce an amount of data transmitted from the personal computer 2 to the liquid crystal projector 3 through the USB cable 4 by selecting an encoding method (JPEG method) capable of greatly compressing data. On the other hand, as for contents data (moving picture contents data or photograph data) for which high definition is requested, it is possible to suppress degradation of quality of an image displayed by the liquid crystal projector 3 to the minimum by selecting an encoding method (run-length method, progressive SPEC; method) which does not cause the degradation of an image.

According to the embodiment described above, even when the communication speed of the USB cable 4 is low and all types of contents data included in one frame cannot be transmitted within a frame update interval, contents data having high transmission priority can be preferentially transmitted. As a result, at least contents data having high transmission priority can be properly displayed. Furthermore, by setting a transmission priority of contents data (moving picture contents data or active data), in which realization of a high frame rate has top priority, to be high, it is possible to hold the frame rate of the corresponding contents data.

### 4. Modifications of Embodiment

The invention is not limited to the above-described embodiment, but various modifications within the scope not departing from the subject matter or spirit of the invention still fall within the technical scope of the invention.

In the embodiment described above, the USB cable 4 is used as a communication unit for data communication between the personal computer 2 and the liquid crystal projector 3. However, the communication unit may be configured by using a LAN cable or a wireless network (for example, IEEE802.11a/11b/11g).

In addition, in the embodiment described above, the image display is performed by transmitting image data acquired by capturing an image displayed on the display 5 of the personal computer 2 to the liquid crystal projector 3. However, in the case when image data, such as a photograph, displayed on the display 5 is stored as raw data on the personal computer 2, high-definition image display based on the raw data may be performed by transmitting the stored raw data to the liquid crystal projector 3 without capturing the image.

What is claimed is:

1. An image display system comprising:
a data processing apparatus that processes image data;
an image display apparatus that displays an image on the basis of the image data processed by the data processing apparatus; and
a communication unit for data communication between the data processing apparatus and the image display apparatus,
the data processing apparatus including:
all image processing unit that performs image processing on image data;
a contents region detection unit that detects contents regions where various types of contents data included in the image data are displayed;
an encoding method selection unit that selects an encoding method corresponding to a type of contents data displayed in each of the contents regions detected by the contents region detection unit;
an encoding unit that encodes the contents data displayed in a corresponding contents region on the basis of the encoding method selected for each of the contents regions by the encoding method selection unit; and
a transmission unit that transmits the various types of contents data, for which the image processing has been performed by the image processing unit and the encoding has been performed by the encoding unit, to the image display apparatus through the communication unit, and
the image display apparatus including:
a receiving unit that receives the various types of contents data transmitted through the communication unit by the transmission unit;
a decoding unit that decodes the contents data in accordance with the encoding method that is selected by the encoding method selection unit for each of various types of contents data received by the receiving unit; and
an image display unit that displays the image on the basis of the various types of contents data decoded by the decoding unit.

2. The image display system according to claim 1,
wherein the data processing apparatus further includes a transmission priority setting unit that sets transmission priorities on various types of contents data included in the image data, and
the transmission unit transmits the various types of contents data based on the transmission priorities set by the transmission priority setting unit.

3. The image display system according to claim 1,
wherein the contents region detection unit includes:
a time change detection unit that detects time change of each pixel data included in the image data; and
a moving picture contents region detection unit that detects a moving picture contents region, in which moving picture contents data included in the image data is displayed, based on the time change of each of the pixel data detected by the time change detection unit.

4. The image display system according to claim 1,
wherein the contents region detection unit includes a boundary detection unit that detects, as a boundary of the contents regions, a large change between adjacent pixel data.

5. An image display method executed by an image display system having a data processing apparatus that processes image data, an image display apparatus that displays an image on the basis of the image data processed by the data processing apparatus, and a communication unit for data communication between the data processing apparatus and the image display apparatus, comprising:
performing image processing on image data by the data processing apparatus;
detecting contents regions in which various types of contents data included in the image data are displayed, by the data processing apparatus;
selecting an encoding method corresponding to the type of contents data displayed in each of the contents regions detected in the detecting of the contents regions, by the data processing apparatus;
encoding the contents data displayed in the corresponding contents region based on the encoding method selected for each of the contents regions in the selecting of the encoding method, by the data processing apparatus:
transmitting the various types of contents data, for which the image processing in the performing of the predetermined image processing and the encoding in the encoding of the contents data have been performed, to the image display apparatus through the communication unit, by the data processing apparatus;
receiving the various types of contents data transmitted through the communication unit in the transmitting of the various types of contents data, by means of the image display apparatus;
decoding corresponding contents data in accordance with an encoding method that is selected in the selecting of the encoding method for each of the various types of contents data received in the receiving of the various types of contents data, by the image display apparatus, and
displaying an image on the basis of the contents data decoded in the decoding of the contents data.

6. An image display program executed by an image display system having a data processing apparatus that processes image data, an image display apparatus that displays an image on the basis of the image data processed by the data processing apparatus, and a communication unit for data communication between the data processing apparatus and the image display apparatus, the image display program causing a computer included in the data processing apparatus to execute:
performing predetermined image processing on image data,
detecting contents regions in which a various types of contents data included in the image data is displayed;
selecting an encoding method corresponding to the type of contents data displayed in each of the contents regions detected in the detecting of the contents regions,
encoding the contents data displayed in the corresponding contents region on the basis of the encoding method selected for each of the contents regions in the selecting of the encoding method; and
transmitting the various types of contents data, for which the image processing in the performing of the predetermined image processing and the encoding in the encoding of the contents data have been performed, to the image display apparatus through the communication unit.

7. A recording medium recorded with the image display program according to claim 6, the recording medium being readable by a computer.

8. An image display program executed by an image display system having a data processing apparatus that processes image data, an image display apparatus that displays an image on the basis of the image data processed by the data processing apparatus, and a communication unit for data communication between the data processing apparatus and the image display apparatus, the image display program causing a computer included in the image display apparatus to execute:
receiving various types of contents data transmitted from the data processing apparatus through the communication unit;
decoding corresponding contents data in accordance with an encoding method that is selected by the data processing apparatus for each of the variety of contents data received in the receiving of the variety of contents data; and
displaying an image based on the various types of contents data decoded in the decoding of the contents data.

9. A recording medium recorded with the image display program according to claim 8, the recording medium being readable by a computer.

10. A data processing apparatus that transmits processed image data to an image display apparatus through a communication unit, comprising:
an image processing unit that performs predetermined image processing on image data;
a contents region detection unit that detects contents regions where various types of contents data included in the image data is displayed;
an encoding method selection unit that selects an encoding method corresponding to the type of contents data displayed in each of the contents regions detected by the contents region detection unit;
an encoding unit that encodes the contents data displayed in the corresponding contents region on the basis of the encoding method selected for each of the contents regions by the encoding method selection unit; and
a transmission unit that transmits the various types of contents data, for which the image processing has been performed by the image processing unit and the encoding has been performed by the encoding unit, to the image display apparatus through the communication unit.

11. An image display apparatus to which image data processed by a data processing apparatus is input through a communication unit and which displays an image on the basis of the processed image data, comprising:
a receiving unit that receives various types of contents data transmitted from the data processing apparatus through the communication unit;
a decoding unit that decodes corresponding contents data in accordance with an encoding method that is selected by the data processing apparatus for each of the various types of contents data received by the receiving unit; and
an image display unit that displays an image based on the various types of contents data decoded by the decoding unit.

12. An image display system comprising:
an image display unit,
a data processing apparatus that
displays a first image,
converts data from the first image based on a type of the image display unit,
detects at least one contents region from the converted data based on a type of contents data in the converted data,
selects an encoding method for each type of contents data in each detected contents region,
encodes each contents data based on the corresponding selected encoding method,
sets a transmission priority of each contents data based on the type of said contents data, and
transmits the encoded data to the image display apparatus; and
a communication unit that communicates between the image display apparatus and the data processing apparatus,
the image display unit receiving the contents data, decoding each contents data based on the corresponding selected encoding method, and displaying a second image based on the decoded contents data.

13. An image display system comprising:
a data processing apparatus that displays a first image and processes image data corresponding to the first image;
an image display apparatus that displays a second image on the basis of the image data processed by the data processing apparatus; and
a communication unit for data communication between the data processing apparatus and the image display apparatus the data processing apparatus including:
an image processing unit that converts image data based on a type of the image display apparatus;
a contents region detection unit that detects a contents region in the first image based on a type of contents data in the first image;
an encoding method selection unit that selects an encoding method corresponding to each contents data;
an encoding unit that encodes the contents data based on the selected encoding method;
a transmission priority setting unit that sets the transmission priority of each contents data based on the type of said contents data; and
a transmission unit that transmits the contents data to the image display apparatus through the communication unit.
